(19) United States
(12) Patent Application Publication
(10) Pub. No.: US 2009/0262790 A1
(43) Pub. Date: Oct. 22, 2009

(54) METHOD OF RECOVERY FROM ACTIVE PORT TX FAILURE IN Y-CABLE PROTECTED PAIR

(75) Inventors: Andrew Molotchko, Kanata (CA); Dave Graham, Kanata (CA); Terry Sellars, Ottawa (CA)

Correspondence Address: MARKS & CLERK, P.O. BOX 957, STATION B, OTTAWA, ON, K1P 5S7, CA

(73) Assignee: ALCATEL LUCENT, Paris (FR)

(21) Appl. No.: 12/104,691

(22) Filed: Apr. 17, 2008

(51) Int. Cl. H04B 1/38

(52) U.S. Cl. 375/220

(57) ABSTRACT

A method is provided for defect recovery in Y-cable protected pair connections in communication systems. A receiver at a remote end monitors for loss of signal on the single fiber optic cable arriving at the remote end, and transmits an RDI back to the local end where it is detected by each of two receivers, one on an active card and one on a standby card. When a persistent RDI is detected by each receiver, transmission of content is flipped from the active transmitter to the standby transmitter, without performing a full APS. If RDIs are no longer received from the remote end, then the defect was likely in the single transmitter of the active card or the single optical fiber leading from the active card to the Y-junction, and the local end realizes that switching transmission to the standby card resolved the problem and a full APS is performed. The invention allows for quick recovery from defects in portions of the Y-cable communication system which may not otherwise be correctable, or even detectable, by conventional higher level fault recovery protocols.

### FIELD OF THE INVENTION

The invention relates to fault recovery in telecommunications, and more particularly to recovery from defects in Y-cable connections.

### BACKGROUND OF THE INVENTION

In a dual-line protected pair optical communication link, a local end and a remote end are coupled by two pairs of optical fibers. The first pair of optical fibers provides communication from a transmitter (Tx) of a first local line card to a receiver (Rx) of a first remote line card, and from a Tx of the first remote line card to a Rx of the first local line card. The second pair of optical fibers provides similar communication between a second local line card and a second remote line card. The first local line card and the first remote line card are working line cards, and the second local line card and the second remote line card are protection line cards. The working line cards are initially active cards, and the protection line cards are initially standby cards. Content is transmitted from the Tx of both cards at the local end, but the content received at the second, standby, remote line card is ignored.

If there is a failure within the active components of the communication link, such as in the Tx of the first local line card or in the first pair of optical fibers, then the first remote line card detects the failure and alerts the local end. Automatic Protection Switching (APS) software then switches the line cards, such that the second local line card and the second remote line card become the active line cards. The second remote line card begins accepting the content transmitted by the Tx of the second local end line card, and the user is alerted that the previously standby line cards are now the active line cards.

The dual-line configuration provides good protection against failure in that full redundancy is provided regardless of where the failure occurs along the first pair of optical fibers, including within the Tx's or Rx's of the active line cards. Furthermore, this failure can usually be easily pinpointed since the Rx on the active remote line card receives content over only a single path.

However, some communication links use a Y-cable protected pair to connect the local end with the remote end. In a Y-cable protected pair configuration, the local end of the communication link has a protected pair of line cards, each with a Tx and a Rx, but the remote end has only one line card with only one Rx and one Tx. An optical fiber from the Tx of each local end line card join together, and then a single optical fiber carries content to the single Rx of the single remote end line card. Similarly, a single optical fiber leads from the single Tx of the single remote end line card, and then splits near the local end so that content is carried over two optical fibers, one optical fiber leading to the Rx of each local end line card. See for example FIG. 1. Since the transmission of each Tx at the local end is eventually carried over a single optical fiber, transmission at the local end is allowed only from the Tx of the active card in order to avoid interference. The Rx of each local end line card receives content from the remote end. Use of a Y-cable may be advantageous if the remote end ports are too expensive to allow use of a protected pair at the remote end. A Y-cable may also be used if optical cabling resources are insufficient, for example only two cables are available instead of four.

Since there is only one remote end line card, protection of the communication link at the remote end is impossible. This includes failure of any component of the remote end line card, and any failure in either optical fiber on the remote end side of the Y-junction. However, protection should be possible if there is a failure of a component on the local end side of the Y-junction since there are two of each component on the local end side.

The difficulty lies in situation in which the local end active Tx fails or the optical fiber between the local end active Tx and the Y-junction fails. In such a case, the local end has no direct knowledge of such a failure. No protocols exist for the remote end to fix such a failure. The remote end may detect a loss of signal (LOS), in which case a Remote Defect Indication (RDI) signal is transmitted back to the line cards at the local end, usually within microseconds, but such signals are currently ignored by the APS software of the local end.

A method of detecting and remedying defects within local end side components of Y-cable communication links would allow communication paths to be protected.

### SUMMARY OF THE INVENTION

In accordance with one aspect of the invention, a method of recovering from a protected end Tx defect in a Y-cable protected pair communication link is provided. Receipt of RDI signals is monitored for at each of an active receiver and a standby receiver at a protected end of the communication link. Any received RDI signals are debounced over a first time period to ensure the RDI signals are persistent. In response to persistent RDI signals at each receiver, transmission is switched from the active transmitter to from the standby transmitter.

After switching from transmission from the active transmitter to transmission from the standby transmitter, the RDI signals may be debounced over a second time period to determine whether the RDI signals have been cleared. If so, APS is performed. If the RDI signals have not been cleared, transmission may be switched back to transmission from the active transmitter.

The methods and apparatus of the present invention allow defects within Y-cable communication links to be detected and potentially remedied in a short enough time that service is not significantly interrupted. By responding to RDI signals sent from the remote end upon detection of a defect in transmission by quickly switching transmitters, it may be possible to re-establish communication between the local end and the remote end in a short time, rather than hoping that a full fault will develop which may or may not be able to be corrected by higher level fault detection protocols.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of a Y-cable protected pair connection between a local end and a remote end of a communications link; and

FIG. 2 is a flowchart of a method carried out by APS software according to one embodiment of the invention.

It will be noted that in the attached figures, like features bear similar labels.

### DETAILED DESCRIPTION OF THE EMBODIMENTS

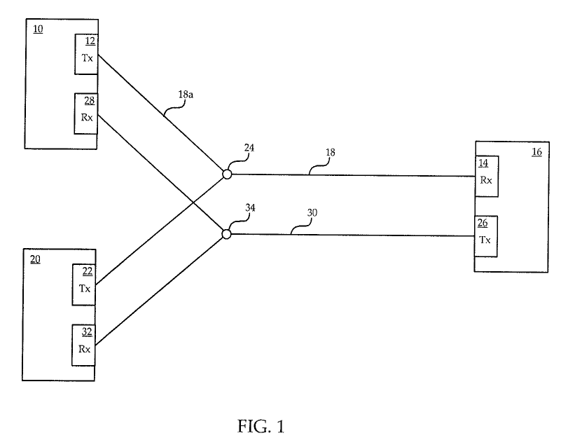

Referring to FIG. 1, a diagram of a Y-cable protected pair connection between a local end and a remote end of a communications link is shown. A first card 10 at a local end of the communication link includes a transmitter (Tx) 12 which communicates with a receiver (Rx) 14 on a second card 16 located at a remote end of the communication link. The Tx 12 communicates with the Rx 14 over a first optical fiber 18. A third card 20 at the local end includes a Tx 22 also in communication with the Rx 14 over the first optical fiber 18, although the Tx of each card at the local end connects to the first optical fiber 18 separately, at a first Y-junction 24.

The second card 16 at the remote end includes a Tx 26 which communicates with a Rx 28 on the first card 10 over a second optical fiber 30. The Tx 26 of the second card 16 also communicates with a Rx 32 on the third card 20 over the second optical fiber 30, although the Rx of each card at the local end connects to the second optical fiber 30 separately, at a second Y-junction 34.

In normal operation, the first card 10 is an active card and the third card 20 is a standby card. The third card 20 is a standby card in that it is intended to provide protection in the event of failure of the active card. In order to avoid interference at the Y-junction 24, only the Tx of the active card 10 transmits content to the card 16 at the remote end, and the Tx of the standby card 20 remains silent. The local end also includes Automatic Protection Switching (APS) software, which may be located on one or both cards 10 and 20, on a separate controller card (not shown), or indeed on any component capable of communicating with and controlling the components of the local end cards 10 and 20. One function of the APS software is to switch transmission from the active card 10 to the standby card 20 upon detection of a fault which renders the active card 10 unable to transmit to the card 16 at the remote end, including alerting a user and thereafter considering the standby card as the active card.

In FIG. 1, the active components are shown as a Tx 12 and a Rx 28 on one line card 10 and the standby components are shown as a Tx 22 and a Rx 32 on a second line card 20. In some implementations, the active Tx and Rx and the standby Tx and Rx are located on the same line card. Generally the Y-cable protected pair connection includes an active Tx and active Rx and a standby Tx and standby Rx at a protected end, and a single Tx and single Rx at an unprotected end. It should be also be noted that the terms “local end” and “remote end” as used herein are merely relative terms, and as used in FIG. 1 the “local end” is the protected end and the “remote end” is the unprotected end of the Y-cable protected pair connection.

Each protected end Rx 28 and 32 listens for signals from the unprotected end Tx 16. One such signal is a Remote Defect Indication (RDI), which is transmitted from the unprotected end card 16 upon detection of Loss of Signal (LOS) by the Rx 14. Each protected end Rx 28 and 32 can detect such RDI signals.

Broadly, the APS software monitors for receipt of RDI signals at each of the protected end receivers 28 and 32. Persistence of the RDI signals is ensured by performing a debounce over a time period. If the RDI signals persist, then transmission from the active transmitter 12 is switched to transmission from the standby transmitter 22.

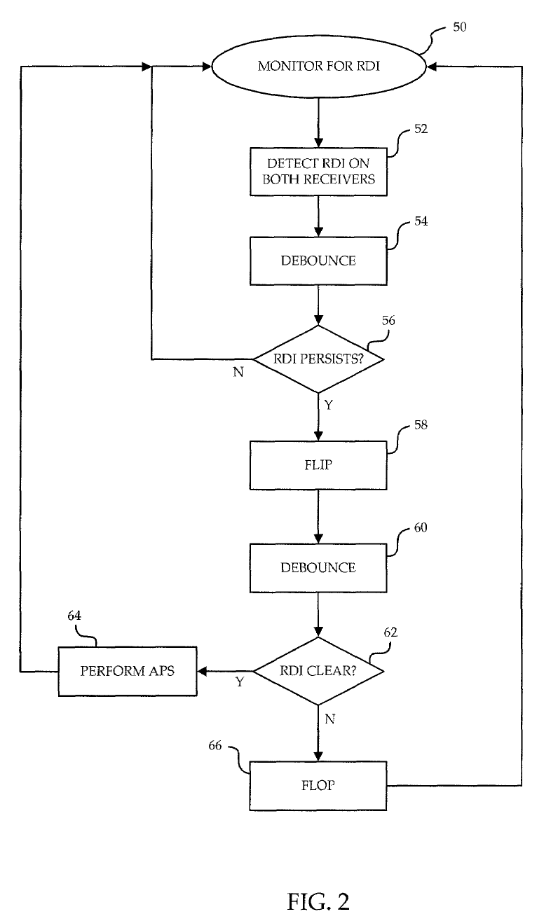

Referring to FIG. 2, a flowchart of a method carried out by the APS software according to one embodiment of the invention is shown. At step 50 the APS software monitors for receipt of an RDI signal at both local end Rx's 28 and 32. At step 52 the APS software detects an RDI signal at both local end Rx's 28 and 32. Receipt of an RDI signal on both Rx's indicates that the remote end has detected a LOS, which suggests that a defect has arisen in a component along the communication path from the active card 10 to the remote end card 16. The defect could have occurred, for example, in the Tx 12, the branch 18a of the first optical fiber which leads to the active card 10, or the main branch 18 of the first optical fiber. It should be emphasized that receipt of an RDI signal at both local end Rx's is monitored for, since receipt of an RDI signal at only one Rx generally indicates a failure of the other local end Rx, and such a defect may not be able to be resolved by simply switching transmission to the standby Tx.

At step 54 the RDI signal is debounced in order to ensure that the RDI signal is persistent beyond a first time period. A suitable time period is 20 ms to ensure that the RDI signal is not transient, since APS should eventually be effected within 50 ms in order to meet the commonly accepted protection switch time and since very transient RDI signals may be transmitted if LOS on the order of microseconds is detected, such as would be the case if the Tx's are switched for other reasons. Debouncing at step 54 ensures that the defect resolution method of the invention does not overreact to transient LOS.

At step 56 the APS software determines whether the RDI signal is persistent based on the debouncing at step 54. If the RDI signal is determined not to be persistent, then the APS software returns to monitoring for receipt of RDI signals at step 50. Otherwise, if the RDI signal is determined to be persistent then the APS software performs a “flip” by switching transmission of content from the Tx 12 on the active card 10 to the Tx 22 on the standby card 20. This is done without performing a full APS. For example, a user is not alerted, no alarms are generated, and the active/standby status of the two local end cards is not changed.

At step 60 another debounce of RDI signals is performed over a second time period, but this time the debounce is to ensure that the RDI signal has been cleared and to ensure that any detected RDI signal is not simply a result of flipping transmission from the Tx of the active card to the Tx of the standby card. A suitable time period for the second debounce is on the order of 50 ms. At step 62 the APS software determines whether the RDI signal has cleared based on the debouncing at step 60. If the RDI signal is determined to have cleared, then the flip executed at step 58 has apparently resolved the defect that caused the LOS and the system has recovered from the defect. This is most likely to have occurred if the defect was a protected end Tx defect, in other words in the Tx 12 of the active card itself or in the branch 18a of the first optical fiber leading to the active card. The switch to the Tx 22 of the standby card has resolved the problem, and the APS software therefore executes a full APS at step 64 so as to designate the standby card 20 as the active card. The APS software then returns to monitoring for an RDI signal at both local end receivers.

If the RDI signal is determined at step 62 not to have cleared, then the flip executed at step 58 has not resolved the defect that caused the LOS. The APS software performs a “flop” by switching transmission from the Tx 22 on the standby card 20 back to the Tx 12 on the active card 10. The APS software then returns to monitoring for receipt of RDI signals on the local end Rx's 28 and 32 at step 50. The method of the invention is a hunting algorithm in that monitoring for RDI signals and attempted corrections by executing “flips” and “flops” between protected end Tx's is a continuous process, and may continue indefinitely until a defect is either resolved by the method of the invention or a higher level fault is detected.

It should be noted that the method of the invention may be halted part way through if a failure of a higher priority (such as LOS or LOF) is detected at the local end and the higher priority failure is processed. For example, if a failure of a higher priority is detected after transmission has been “flipped” to the standby Tx but before full APS is executed, transmission will “flop” back immediately to the active Tx and the higher priority failure will be processed instead.

In order to prevent overreaction to transient LOS and to prevent instability caused by LOS arising from switching between protected end transmitters, various pauses and additional debounces may be added to the method of the invention. For example, the APS software may pause a short while after performing the flop at step 66, a suitable delay being 10 s. This also allows time for higher level protocols to attempt to detect the loss of communication if the defect persists long enough to be detected as a fault or cannot be resolved by the defect correction method of the invention. For example, if the defect occurred in the main branch of the first optical fiber leading from the Y-junction 24 to the remote end card 16 then higher level fault detection protocols may detect the fault, which may require manual correction. The APS software may also pause a short while after performing a full APS at step 64, a suitable delay being 3 s, in order for the system to stabilize before checking for new RDI signals.

The various times described above, such as for debouncing, are only approximate. Experimentation and optimization may reveal more appropriate times, and the specific times used will be implementation-dependant. As a guide, the debounce time used at step 54 should be long enough to ensure that the defect triggering the RDI signals is persistent and yet short enough that the defect can be resolved quickly. Recommended (but not necessary) times are: 20 to 40 ms for debouncing to detect persistent RDI signals (described with reference to step 54); 50 to 100 ms for debouncing to detect clearance of RDI signals (described above with reference to step 60); 10 to 15 s for pausing after reverting to the active Tx 12 following failure of the RDI signals to clear (described above in paragraph 25); and 3 to 5 s for pausing after performing a full APS (described above in paragraph 25).

In one embodiment, failure of the “flip” to recover from the defect ends the algorithm since it may be deemed unnecessary for transmission to revert to the active Tx 12, since this lead to the defect in the first place. In such an embodiment, the steps 60, 62, 64, and 66 are removed from the method described above with reference to FIG. 2. Following switching of transmission from the active Tx 12 to the standby Tx 22 the algorithm simply waits, in the expectation that the persistent defect may eventually either cause a fault which can be detected and corrected by higher level fault-protection protocols, or cause a fault which requires manual recovery. The waiting time could be indefinite until reset following manual correction of the defect. The decision as to whether to repeatedly switch back and forth between the local end Tx's or to attempt only a single protection will depend on implementation factors, such as how much processing power is to be dedicated to a hunting algorithm and how advantageous early recovery from defects is deemed to be.

The invention is preferably implemented as software, which may be in the form of processing instructions on either or both line cards, on a control card in communication with the line cards, or indeed anywhere as long as the software is able to control the physical components of the line cards such as the transmitters and receivers. Alternatively, the invention may be implemented as hardware, or as a combination of hardware and software. What has been described as carried out by the APS software may be carried out more generally by an APS function, which may be any combination of software or hardware. Any processing instructions may be stored on a computer-readable medium.

The embodiments presented are exemplary only and persons skilled in the art would appreciate that variations to the embodiments described above may be made without departing from the spirit of the invention. For example, methods which are logically equivalent to the method described above with respect to FIG. 2 may be used.

We claim:

1. A method of recovering from a protected end Tx defect in a Y-cable protected pair communication link, the method comprising:
monitoring for receipt of Remote Defect Indication (RDI) signals at each of an active receiver and a standby receiver at a protected end of the communication link;
debouncing any received RDI signals over a first time period to ensure the RDI signals are persistent; and
in response to RDI signals at each receiver which persist, switching from transmission from an active transmitter to transmission from a standby transmitter.

2. The method of claim 1 further comprising, after switching from transmission from the active transmitter to transmission from the standby transmitter:
debouncing the RDI signals over a second time period to determine whether the RDI signals have been cleared; and
if it is determined that the RDI signals have been cleared, performing Automatic Protection Switching.

3. The method of claim 2 further comprising:
if it is determined that the RDT signals have not been cleared, switching from transmission from the standby transmitter back to transmission from the active transmitter.

4. The method of claim 3 further comprising:
after switching from transmission from the standby transmitter back to transmission from the active transmitter, monitoring for receipt of RDI signals at both receivers again; and
repeating the method continuously so as to continuously monitor for RDI signals and so as to attempt to remove any persistent RDI signals by switching back and forth between transmission from the active transmitter and transmission from the standby transmitter.

5. The method of claim 4 further comprising pausing for a third time period before monitoring for receipt of RDI signals at both receivers again.

6. The method of claim 5 wherein the third time period is between 10 s and 15 s.

7. The method of claim 1 wherein the first time period is between 20 ms and 40 ms.

8. The method of claim 4 wherein the first time period is between 20 ms and 40 ms.

9. The method of claim 2 wherein the second time period is between 50 ms and 100 ms.

10. The method of claim 4 wherein the second time period is between 50 ms and 100 ms.

11. The method of claim 5 wherein the first time period is between 20 ms and 40 ms, the second time period is between 50 ms and 100 ms, and the third time period is between 10 s and 15 s.

12. A computer-readable medium containing instructions for recovering from a protected end Tx defect in a Y-cable protected pair communication link, the instructions comprising:
instructions for monitoring for receipt of Remote Defect Indication (RDI) signals at each of an active receiver and a standby receiver at a protected end of the communication link;
instructions for debouncing any received RDI signals over a first time period to ensure the RDI signals are persistent; and
instructions for switching from transmission from an active transmitter to transmission from a standby transmitter in response to persistent RDI signals at each receiver.

13. The computer-readable medium of claim 12 further comprising:
instructions for debouncing the RDI signals over a second time period to determine whether the RDI signals have been cleared after switching from transmission from the active transmitter to transmission from the standby transmitter; and
instructions for performing Automatic Protection Switching if it is determined that the RDI signals have been cleared.

14. The computer-readable medium of claim 13 further comprising:
instructions for switching from transmission from the standby transmitter back to transmission from the active transmitter if it is determined that the RDI signals have not been cleared.

15. The computer-readable medium of claim 14 further comprising:
instructions for monitoring for receipt of RDT signals at both receivers again, after switching from transmission from the standby transmitter back to transmission from the active transmitter; and
instructions for repeating the method continuously so as to continuously monitor for RDI signals and so as to attempt to remove any persistent RDI signals by switching back and forth between transmission from the active transmitter and transmission from the standby transmitter.

16. The computer-readable medium of claim 15 further comprising instructions for pausing for a third time period before monitoring for receipt of RDI signals at both receivers again.
